(19) United States
(12) Patent Application Publication
(10) Pub. No.: US 2006/0248739 A1
(43) Pub. Date: Nov. 9, 2006

(54) Firearm headspace gauge

(75) Inventor: Dennis Cauley, Booneville, MO (US)

Correspondence Address: David T. Dutcher;PERKINS COIE LLP, P.O. BOX 1247, Seattle, WA, 98111-1247, US

(73) Assignee: Battenfeld Technologies, Inc., Columbia, MO (US)

(21) Appl. No.: 11/311,530

(22) Filed: Dec. 19, 2005

Related U.S. Application Data
(60) Provisional application No. 60/637,009, filed on Dec. 17, 2004.

(51) Int. Cl. G01D 21/00

(52) U.S. Cl. 33/506

(57) ABSTRACT

A headspace gauge for measuring the headspace of a chamber of a firearm. The gauge has a rear face for contacting a bolt face of the firearm and a curved front portion including a circumferential contact portion for contacting an angled surface of the chamber. The circumferential contact portion is spaced apart from the rear face by a predetermined distance.

### CROSS-REFERENCE TO RELATED APPLICATION

This application is a non-provisional of U.S. Provisional Patent Application Ser. No. 60/637,009, filed Dec. 17, 2004, which is incorporated herein by reference.

### BACKGROUND OF THE INVENTION

This invention relates generally to a headspace gauge, and more particularly to a headspace gauge for measuring headspace for rimless, bottleneck cartridges of a firearm.

Headspace is a critical dimension in a firearm that indicates the distance between the face of the breech, the part of the firearm mechanism that contacts the rear face of a cartridge case, and the surface of the chamber that prevents the cartridge case from moving forward (the firearm's chamber is a cavity in the barrel that the cartridge is inserted into before firing). This dimension is an important dimension of the firearm. If the headspace is excessive, or exceeds accepted industry manufacturing standards, the cartridge case may rupture upon firing of the cartridge. If the headspace is insufficient, the chamber may be short enough that a cartridge manufactured within approved industry standards cannot be fully enclosed and chambered in the firearm. Because of the problems created by excessive or insufficient headspace, headspace gauges are essential when building a new rifle, installing a new barrel on an older rifle, switching barrels on a rifle, chambering a barrel for a different cartridge, or checking the dimension of a used rifle for wear.

Typically a firearm's headspace is checked relative to industry standards with caliber-specific go and no-go gauges. Headspace gauges are normally furnished in three different length increments. The minimum length gauge, generally referred to as a “Go Gauge”, is used to ensure that the chamber is of the acceptable minimum length. In use the “Go Gauge” must enter the chamber and the breech bolt must close and lock completely. If the breech bolt will not close and lock completely, then the chamber is too short and the headspace is below the minimum acceptable standards for the firearms industry.

The next larger size headspace gauge is a “No-Go Gauge” that is sized to slightly exceed the maximum acceptable chamber length. In use, the No-Go gauge is inserted into the chamber and the breech bolt moved into the closed and locked position. If the breech bolt can close on the No-Go Gauge then this indicates that the chamber length and headspace is longer than acceptable industry standards. In a properly machined firearm having a properly sized chamber, the breech bolt will not close or lock completely when a No-Go Gauge is placed in the chamber.

The third, and longest headspace gauge is often referred to as a “Field Gauge”. A Field Gauge is generally at least 0.006″ longer than the No-Go gauge. The Field Gauge measures the largest acceptable size of the chamber.

While headspace gauges are commercially available as Go, No-Go, and Field Gauges, headspace gauges can also be used in multiple gauge sets in increments of as little as 0.001″ ranging from the minimum acceptable headspace to well beyond maximum acceptable headspace. Typically multiple gauge sets are used by gunsmiths who work on highly accurate rifles for long-range shooting to accurately measure and adjust the size of the chamber to exact specifications.

The present invention relates to headspace gauges for a specific type of firearm cartridge referred to as a rimless, bottleneck cartridge or case. A rimless, bottleneck case is not actually rimless, but rather, the case has a rim at the rear portion of the case that is identical in diameter to the case body and a neck diameter at the front portion of the case that is smaller in diameter than the case body. The smaller diameter neck transitions to the larger diameter body via an angled shoulder at the front of the case body.

The chamber of a firearm for this type of cartridge has the same general shape as the cartridge case. Headspace of a firearm chambered for a rimless, bottleneck cartridge is determined by the distance from the breech, or bolt, face to a theoretical datum line located at the approximate midpoint of the angled shoulder in the chamber. This datum line represents the point on the chamber surface that limits the forward travel of the cartridge inside the chamber.

Headspace gauges are typically machined as a single piece from steel to resist wear and ground to specific, tightly controlled dimensions. The most critical parts of the gauge are the rear base, or face, that interfaces with the breech face of the bolt and the angled portion that interfaces with the interior shoulder of the chamber at the location of the datum line. Typical commercially available headspace gauges are shaped similarly to the cartridge case for a specific chamber. Their design consists of a cylindrical body corresponding to the case body and a tapered, or conical, front face corresponding to the angled shoulder.

The angle dimension of the conical shoulder on the gauge must be tightly controlled to ensure the datum line of the chamber is located correctly. This is difficult to achieve and requires precise machining of the gauge since the angle of the shoulder is determined by the distance of the two endpoints of the shoulder from the gauge base and the diameter of the gauge body at that longitudinal distance. Therefore, four critical dimensions are necessary to properly create the angle of the shoulder. The present invention simplifies existing headspace gauge designs by replacing the conical end of the gauge with a curved end which in one embodiment has a rounded, hemispherical shape. The hemispherical end is dimensioned such that it will contact the chamber datum line in the same manner as the conical end of typical headspace gauges. The hemispherical end is easier to manufacture than the conical end because it is controlled by a single longitudinal distance from the gauge base and a single diameter of the gauge body.

### SUMMARY OF THE INVENTION

Among the several objects of the invention may be noted the provision of an apparatus that aids the user in accurately determining the headspace of a firearm chambered for a rimless rifle cartridge. The apparatus employs a unique design feature as the forward point of contact of the forward end of the cylindrical gauge has a rounded shape rather than a traditional conical shape. In one embodiment, the forward end of the gauge is a truncated hemisphere having a substantially planar forward end. The use of a hemispherical surface on this portion of the gauge simplifies production and allows the manufacturer a greater degree of control over the exact diameter of the gauge at the point where it will contact the datum line within the chamber.

Generally, a headspace gauge of the present invention for measuring the headspace of a chamber of a firearm comprises a rear face for contacting a bolt face of the firearm and a curved front portion including a contact portion for contacting an angled surface of the chamber. The contact portion being spaced apart from the rear face by a predetermined distance.

In another aspect, the comprises a flat rear face for contacting a bolt face of the firearm and a curved front portion including a circumferential contact portion for contacting an angled surface of the chamber. The circumferential contact portion being spaced apart from the rear gauge face by a predetermined distance. The gauge comprises a cylindrical main body portion that is generally adjacent the curved front portion, an intermediate body portion that is between the rear face and the main body portion, an annular section of reduced diameter between the main body portion and the intermediate body portion, and a rear body portion comprising the rear face of the gauge. The rear body portion having a recessed annular shoulder generally adjacent the intermediate body portion.

Other objects and features will be in part apparent and in part pointed out hereinafter.

### BRIEF DESCRIPTION OF THE DRAWINGS

FIG. 1 is a side view of a typical rimless, bottleneck cartridge.

FIG. 2 is an exploded perspective view of a bolt-action rifle showing the bolt retracted and a cartridge being inserted into the chamber.

FIG. 3 is perspective view of a bolt-action rifle with the bolt closed and locked.

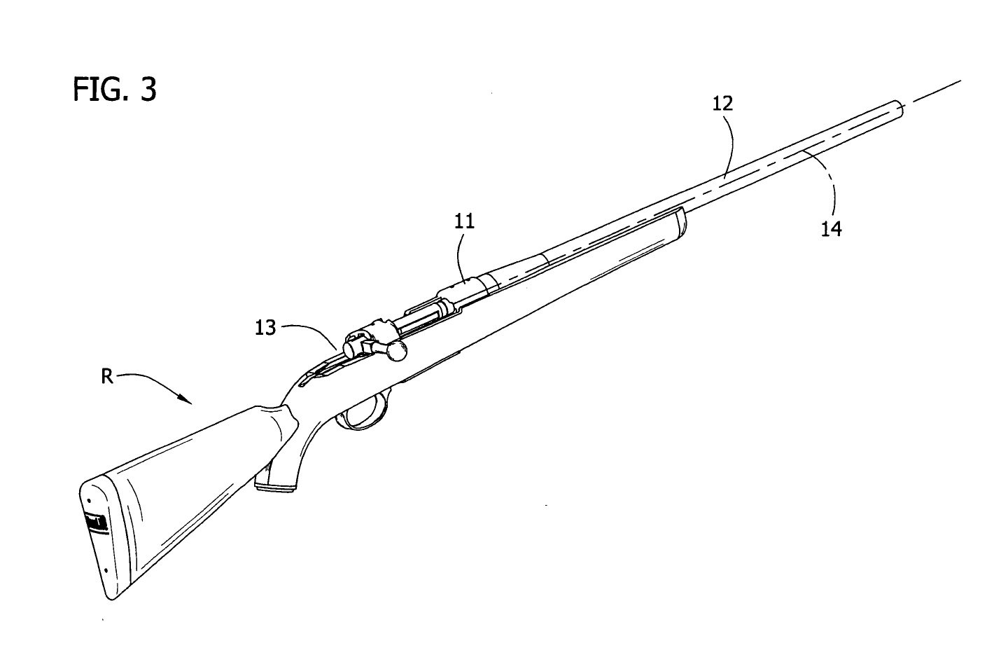

FIG. 4 is a side view of a bolt-action rifle.

FIG. 5 is an enlarged, fragmentary cross-section along plane 5-5 of FIG. 4.

FIG. 6 is a cross-section similar to FIG. 5 but showing a cartridge in the chamber.

FIG. 7 is a side view of a prior art headspace gauge.

FIG. 8 is a cross-section of a rifle chamber with the prior art headspace gauge in the chamber.

FIG. 9 is a side view of a headspace gauge of the present invention.

FIG. 10 is a cross-section of a rifle chamber with the headspace gauge in the chamber.

FIG. 10A is an enlarged portion of FIG. 10.

FIG. 11 is a perspective view of the present invention installed in a bolt-action rifle.

FIG. 12 is an enlarged detail of FIG. 11.

Corresponding parts are designated by corresponding reference numbers throughout the drawings.

### DESCRIPTION OF THE PREFERRED EMBODIMENT

The preferred embodiment of the invention is used to determine the headspace of a firearm (e.g., bolt-action rifle R) designed to shoot a rimless, bottleneck cartridge C. The headspace of a firearm is a critical dimension in firearm manufacture and performance.

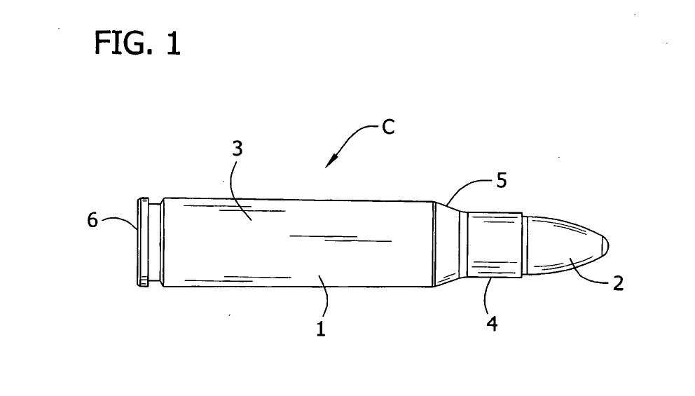

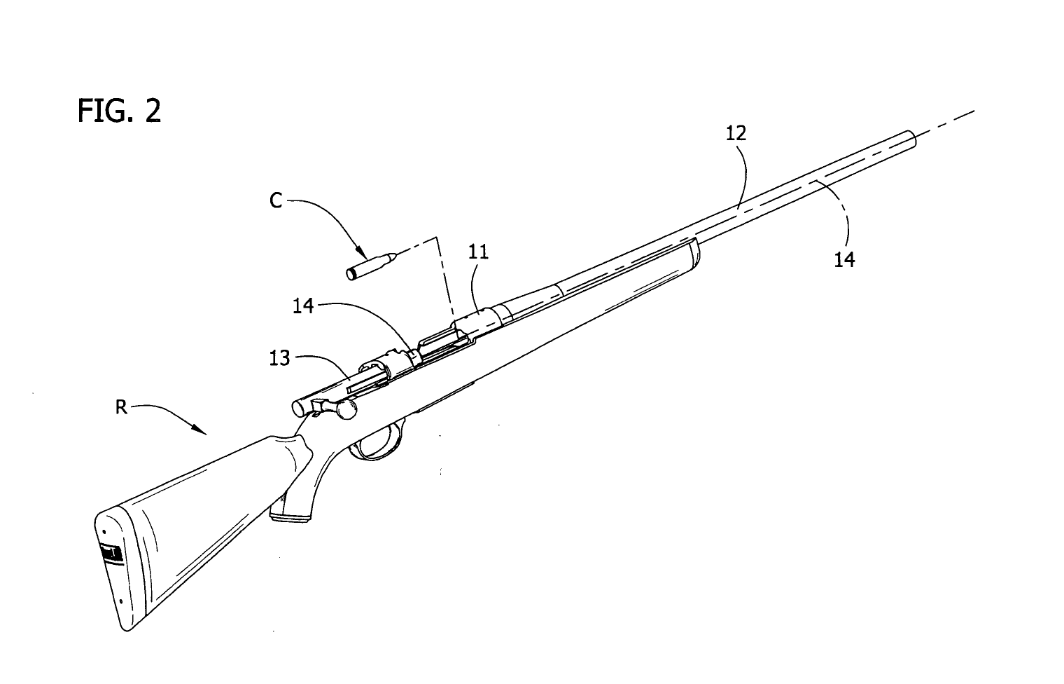

The basic construction of a typical rimless, bottleneck cartridge (case) C is shown in FIG. 1. The case C, usually swaged from brass, holds a bullet 2 and gunpowder together in a single unit. The case C has a body 3 with an interior that contains gunpowder and a neck 4 that centers and supports the bullet 2. The case C has an angled shoulder 5 between the neck 4 and the body 3 and a rear face 6. As described in further detail herein, the angled shoulder 5 and rear face 6 contact respective surfaces of the firearm R to restrict translational movement of the cartridge C when loaded in the firearm R. FIG. 2 shows the cartridge C being inserted into a typical bolt-action rifle R consisting of a receiver 11, barrel 12 and bolt 13. Upon insertion into the rifle R, the bolt 13 is closed so the cartridge C is retained inside the rifle R generally aligned with the longitudinal axis 14 of the barrel 12.

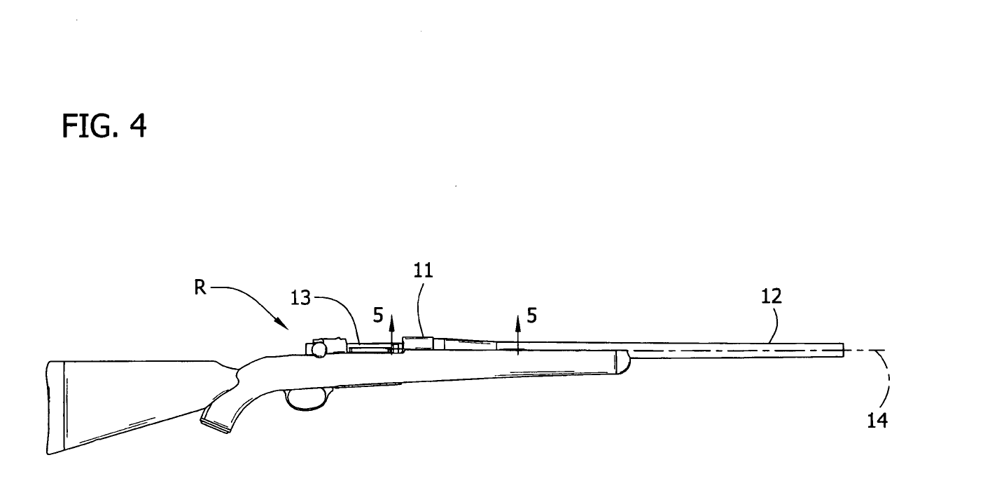

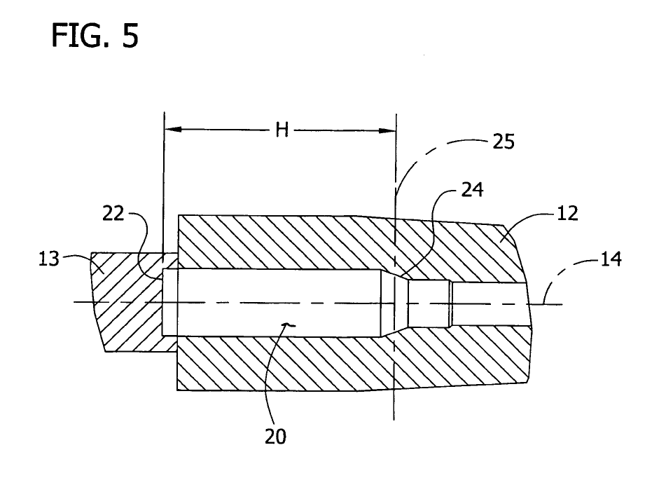

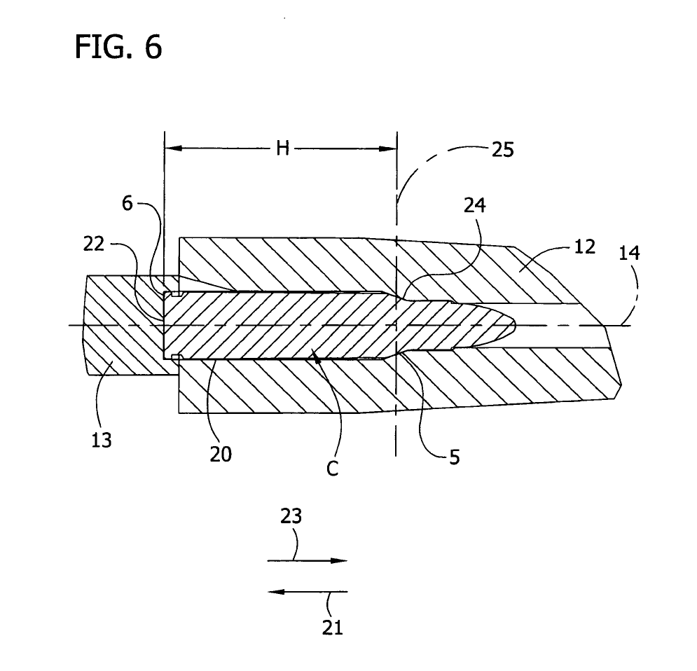

Referring to FIGS. 4 through 6, the rifle chamber 20 is a cavity of the same shape and approximate size of the cartridge C machined into the barrel 12 along its longitudinal axis 14. The chamber 20 houses and centers the cartridge C with the barrel 12 for firing of the cartridge C. The bolt 13 has a bolt face 22 that closes the rear of the chamber 20 and contacts the rear face 6 of the cartridge C to restrict rearward translational movement of the cartridge C in the direction of arrow 21. Forward translational movement of the cartridge C in the direction of arrow 23 (FIG. 6) is restricted by contact between an angled annular surface 24 of the barrel 12 and the shoulder 5 of the cartridge. Headspace H, as used herein, is defined as the distance between the bolt face 22 and a datum line 25 located at the approximate midpoint of the angled surface 24 at the forward end of the chamber 20. Firearm industry standards dictate required headspace for all commercially available firearm cartridges. The datum line 25 locates the theoretical forward contact point of the cartridge C and the barrel 12 when the cartridge is loaded in the chamber 20 and the chamber is of optimum dimension.

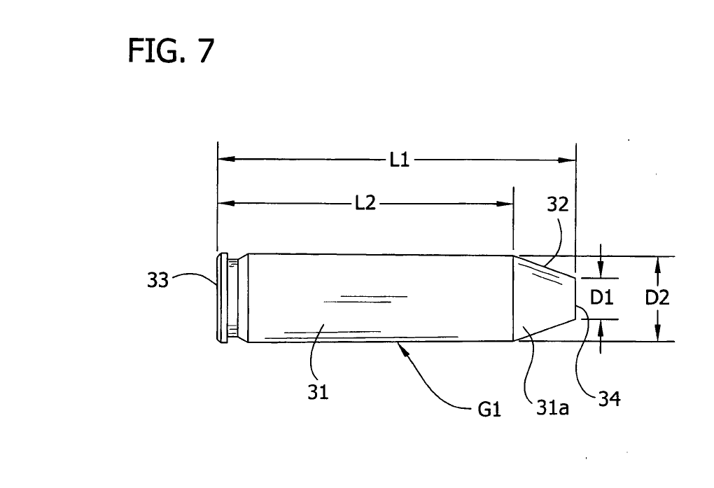

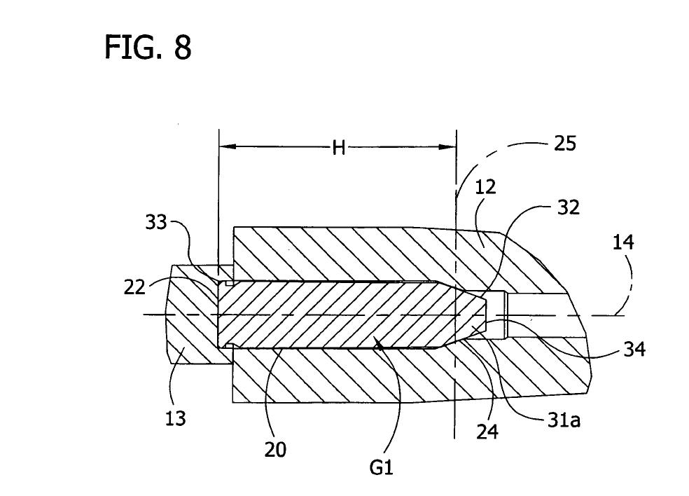

A typical (prior art) headspace gauge G1 is machined as a single piece from hardened steel (see FIG. 7). The gauge G1 has a cylindrical body 31 and a truncated conical end 31a having an angled shoulder 32 that correspond to the shape and dimensions of the chamber 20. The gauge G1 has a rear face 33 at the rear of the cylindrical body 31 and a forward face 34 at the truncated conical end 31a. FIG. 8 shows the relationship of the rear face 33 with the bolt face 22 of the bolt 13 and the angled shoulder 32 with the annular surface 24 of the barrel 12. In order for the headspace gauge G1 to correctly measure headspace H it is necessary for the distance from the gauge face 33 to the approximate midpoint of the angled shoulder 32 to equal the headspace H dimension. Accordingly, the angle of the shoulder 32 and the other dimensions of the gauge G1 must be very precise. The gauge G1 must be machined such that the longitudinal dimensions L1, L2 (FIG. 7) and the two diametrical dimensions D1, D2 have extremely small tolerances so that the shoulder 32 is accurately located to contact the annular surface 24 of the barrel 12 at a precise location corresponding with the headspace H of the chamber 20. For those accomplished in the art of machining this is a difficult and time-consuming task, causing manufacturing of existing headspace gauges G1 to be expensive.

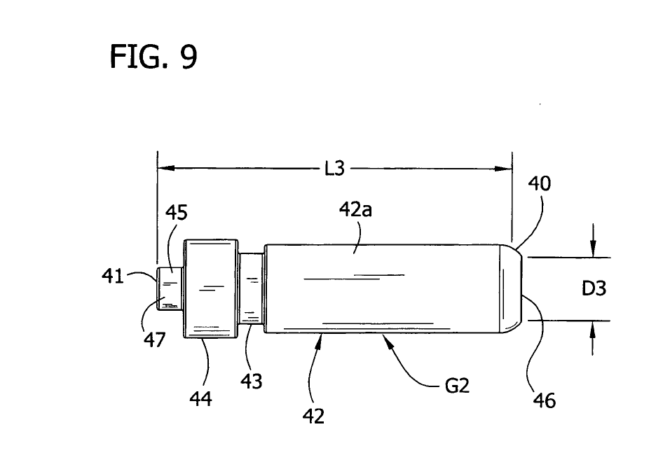

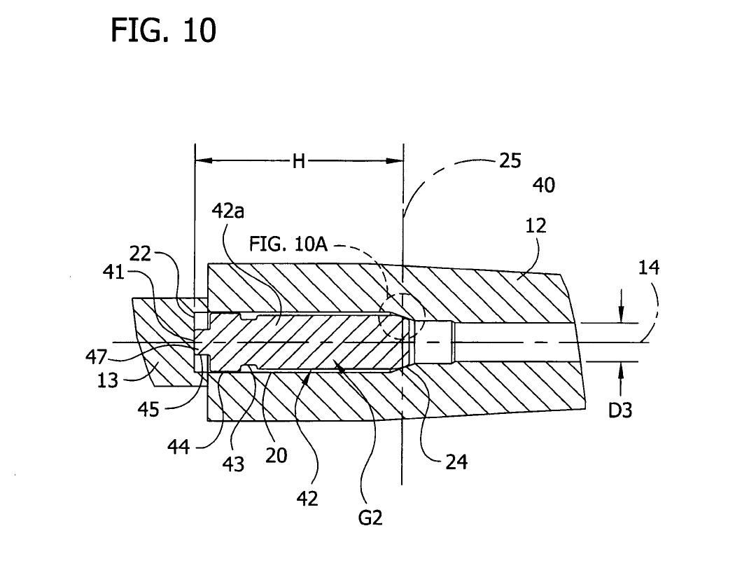

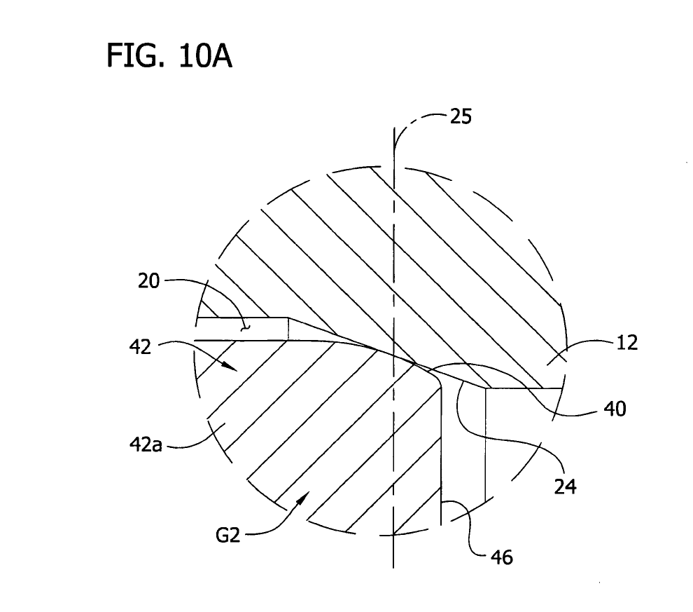

As shown in FIG. 9, the headspace gauge G2 of the present invention improves over common headspace gauges by replacing the angled gauge shoulder 32 with a curved surface 40 at the front portion of the gauge. The gauge G2 is used in the same manner as common headspace gauges G1 to check the headspace H of the chamber 20, but is less expensive to manufacture. The gauge G2 has a cylindrical body, generally indicated 42, a flat rear face 41 that contacts the bolt face 22 of the bolt 13, and a flat forward surface 46. The surface 40 provides a curved front portion of the gauge G2 between the cylindrical body 42 and the flat forward surface 46. In the illustrated embodiment, the surface 40 is a rounded, convex surface but it is understood that the surface could included other curves such as a curve having a varying radius of curvature over at least a portion of the length of the curved surface. When the gauge G2 is placed in the chamber 20 as shown in FIG. 10, the rear face 41 makes contact with the bolt face 22 and the curved surface 40 makes contact with the angled surface 24 of the chamber 20 at the datum line 25. As shown in FIG. 10A, the curved surface 40 contacts the angled surface 24 of the barrel 12 at a circumferential contact surface that corresponds with the intersection of the datum line 25 with the midpoint of the angled contact surface. In the illustrated embodiment, the curved surface 40 contacts the angled surface 24 along the full circumference of the gauge G2. It is understood that the gauge G2 may have a body including a curved front portion having a surface that contacts the angled surface 24 along only an arcuate portion of the cylindrical body comprising less than the full circumference of the gauge without departing from the scope of this invention. In the illustrated embodiment, the circumferential contact surface has a diameter D3 located a length L3 away from the rear face 41. Therefore, to machine a gauge G2 corresponding with the headspace H of chamber 20, only the diameter D3 of the circumferential contact surface on the curved surface 40 of the gauge and the distance L3 of the contact surface from the rear face 41 must be controlled within precise tolerances to properly size the gauge.

The gauge G2 may be machined as a single piece from hardened steel or other suitable material. The cylindrical body 42 has a main body portion 42a, an annular section 43 having a reduced diameter, an intermediate body portion 44 having generally the same diameter as the main body portion, and a rear body 47 portion having a reduced diameter. The annular section 43 serves as a relief cut between the main body portion 42a and the intermediate body portion 44 to eliminate any protruding corners that may interfere with the chamber 20 during use. The intermediate body portion 44 diameter closely matches that of the chamber 20 to keep the gauge G2 aligned with the longitudinal axis 14 of the barrel 12 and chamber 20.

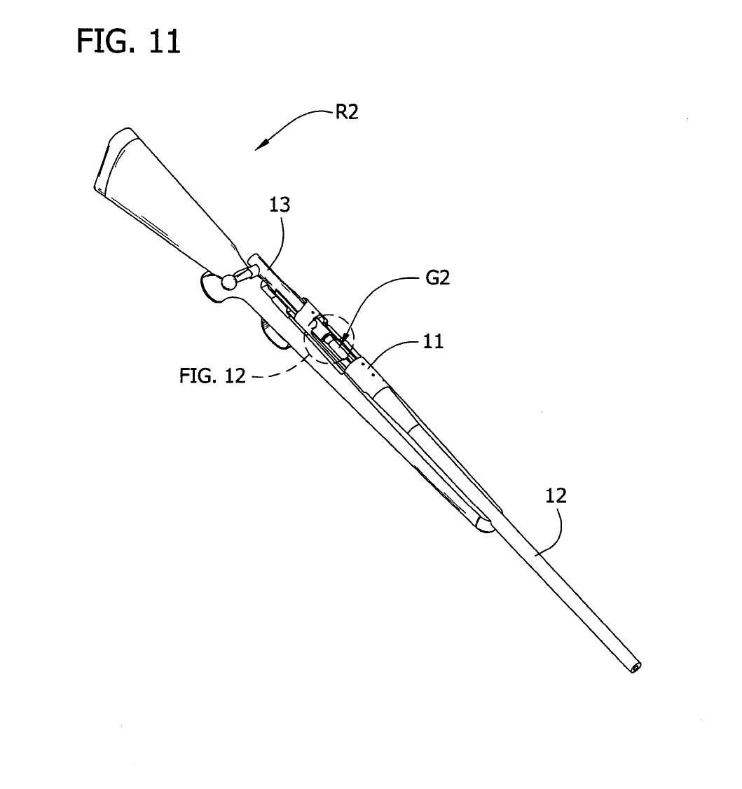

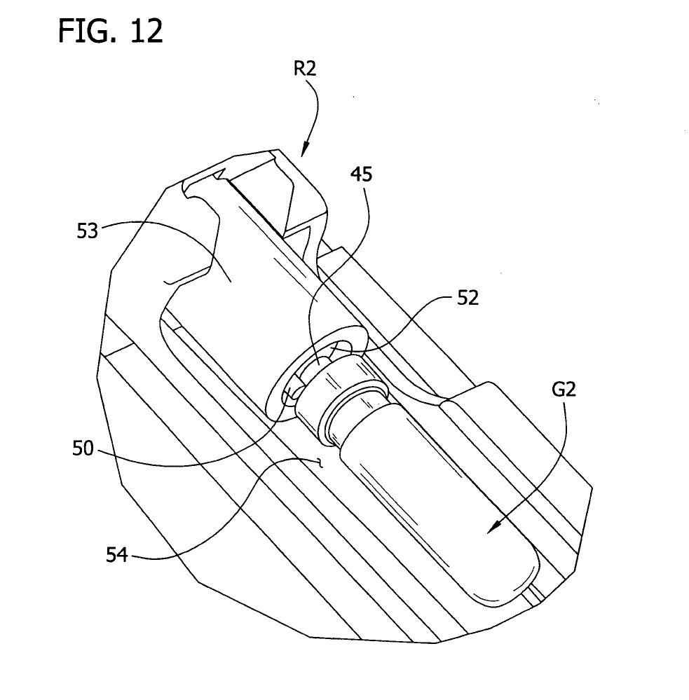

The rear body portion 47 comprises the rear face 41 of the gauge G2 and forms a recessed annular shoulder 45 generally adjacent the intermediate body portion 44. As compared to the typical gauge G1, the rear face 41 of the gauge G2 has a much smaller diameter than the rear face 33 (FIG. 7) of the typical gauge. The annular shoulder 45 is shaped for receiving a spring-loaded ejector 50 (FIG. 12) of the rifle R. The ejector 50 is a spring-loaded cylindrical steel pin retained in the bolt 53 that protrudes from the bolt face 52 of some commercially available rifles R2 to apply pressure against the case face 6 to aid in removal of the case from the chamber 54 after firing. The rear body portion 47 of the gauge G2 is shaped to receive the ejector 50 adjacent the annular shoulder 45 to eliminate the interference between the gauge and the ejector of the rifle R (see FIGS. 11, 12). If a typical gauge G1 is used to measure headspace, the ejector 50 must be removed from the bolt 53 before the gauge G1 is inserted into the chamber 54. The design of the gauge G2 of the present invention allows the headspace H of the rifle R to be checked without the extra step of removing the ejector 50.

It will be understood that the headspace gauge G2 of the present invention may be a Go Gauge, a No-Go Gauge, a Field Gauge, or any other type of gauge used to check headspace of a rifle. If the headspace gauge G2 is a Go Gauge the length L3 between the rear face 41 and the circumferential contact surface of the curved surface 40 will correspond with the minimum acceptable headspace of the rifle R. If the headspace gauge G2 is a No-Go gauge or a Field Gauge, the length L3 between the rear face 41 and the circumferential contact surface of the curved surface 40 will be greater than the maximum acceptable headspace of the rifle.

In use, the headspace gauge G2 is inserted into the chamber 20 of the barrel 12. Next, the bolt 13 is moved to the closed position with light pressure. If the gauge G2 is a Go Gauge, the bolt 13 should close. If the bolt 13 does not close on the gauge G2, the headspace H of the rifle R is not large enough and the rifle should not be fired until modifications are made to the chamber 20 to correctly size the headspace.

If the bolt 13 closed on the gauge G2, the bolt is then opened and the Go Gauge is removed and a No-Go Gauge G2 is placed in the chamber 20. Next, the bolt 13 is moved to the closed position using very light pressure with thumb and forefinger only, until contact with the gauge G2 is felt. The bolt 13 should not be forced to close as the bolt should not close on the No-Go gauge G2. If the bolt 13 closed completely on the NO-Go gauge G2, the headspace H is beyond maximum standards and the rifle should not be fired without adjusting the headspace.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense. For example, the gauge G2 could be used on any suitable firearm capable of firing suitable types of cartridge. In one example, the gauge G2 is used on a bolt action rifle R capable of firing a rimless, bottleneck, centerfire cartridge C. The dimensions of the gauge G2 are machined to match the industry standards for headspace H for a specific cartridge C and firearm R.

In view of the above, it will be seen that the several objects of the invention are achieved and other advantageous results attained.

What is claimed is:

1. A headspace gauge for measuring the headspace of a chamber of a firearm, the gauge comprising a rear face for contacting a bolt face of the firearm, a curved front portion including a contact portion for contacting an angled surface of the chamber, the contact portion being spaced apart from the rear face by a predetermined distance.

2. The headspace gauge set forth in claim 1 wherein said predetermined distance is equal to a minimum acceptable headspace of the chamber needed to properly fire the firearm.

3. The headspace gauge set forth in claim 1 wherein said predetermined distance is greater than a maximum acceptable headspace of the chamber needed to properly fire the firearm.

4. The headspace gauge set forth in claim 1 wherein the gauge comprises a cylindrical main body portion generally adjacent the curved front portion, an intermediate body portion, and a rear body portion comprising the rear face.

5. The headspace gauge set forth in claim 4 further comprising an annular section of reduced diameter between the main body portion and the intermediate body portion.

6. The headspace gauge set forth in claim 4 wherein the rear body portion comprises a recessed annular shoulder generally adjacent the intermediate body portion.

7. The headspace gauge set forth in claim 1 wherein the gauge comprises a single piece of hardened steel.

8. The headspace gauge set forth in claim 1 wherein the gauge is a go gauge.

9. The headspace gauge set forth in claim 1 wherein the gauge is a no-go gauge.

10. The headspace gauge set forth in claim 1 wherein the gauge is a field gauge.

11. The headspace gauge set forth in claim 1 wherein said contact surface is a circumferential contact surface extending around a circumference of the gauge.

12. The headspace gauge set forth in claim 1 wherein said curved front portion includes a rounded surface.

13. A headspace gauge for measuring the headspace of a chamber of a firearm, the headspace gauge comprising:
a flat rear face for contacting a bolt face of the firearm;
a curved front portion including a circumferential contact portion for contacting an angled surface of the chamber, the circumferential contact portion being spaced apart from the rear gauge face by a predetermined distance;
a cylindrical main body portion generally adjacent the curved front portion;
an intermediate body portion between the rear face and the main body portion;
an annular section of reduced diameter between the main body portion and the intermediate body portion; and
a rear body portion comprising the rear face of the gauge, the rear body portion having a recessed annular shoulder generally adjacent the intermediate body portion.

14. The headspace gauge set forth in claim 13 wherein said predetermined distance is equal to a minimum acceptable headspace of the chamber needed to properly fire the firearm.

15. The headspace gauge set forth in claim 13 wherein said predetermined distance is greater than a maximum acceptable headspace of the chamber needed to properly fire the firearm.
